(19) United States
(12) Patent Application Publication
(10) Pub. No.: US 2015/0371343 A1
(43) Pub. Date: Dec. 24, 2015

(54) METHOD FOR PROVIDING SOCIAL NETWORK SERVICE AND CONTENT

(71) Applicant: NAVER CORPORATION, Seongnam-si (KR)

(72) Inventor: Yung Seong Lee, Seongnam-si (KR)

(21) Appl. No.: 14/743,481

(22) Filed: Jun. 18, 2015

(30) Foreign Application Priority Data
Jun. 19, 2014 (KR) 10-2014-0074655

(51) Int. Cl. G06Q 50/00; H04L 29/06; G06F 17/30

(52) U.S. Cl. CPC G06Q 50/01; G06F 17/30867; H04L 65/403; G06F 17/30598

(57) ABSTRACT

A method for providing a social network service for providing a communication space among subscribers belonging to a group online includes providing, by an SNS server, a group category in units of objects according to a request for group establishment by a service subscriber, generating, by the SNS server, a social network group related to a category selected by the service subscriber, storing, by the SNS server, the generated social network group in correspondence to the group category, and providing content related to a category of the social network group. According to an embodiment, it is possible to provide meaningful content to groups, and the availability of the advertising business in SNS can be improved.

### BACKGROUND OF THE INVENTION

1. Field of the Invention

The present invention relates, in general, to a method of providing a social network service for communicating with other persons, and more particularly, to a method for providing and establishing a content social network service group suitable for consuming content of interest, and providing and managing content for a corresponding group.

2. Description of the Related Art

As well known to those skilled in the art, a service called a social network service (SNS) reinforces personal connections with acquaintances such as friends, old classmates, companions, and the like, and allows new contacts to be made and wide human networks to be built. As the personal desire for expression grows strong, an SNS has also developed to allow people to build social relationships and further their relationships with each other. Recently, due to the forced openness of SNS, represented by the likes of Twitter, Facebook, or the like, so-called ‘closed SNS’ has come under the spotlight.

Unlike open SNS, closed SNS enables communication with a limited small size group, and carries a reduced risk of privacy violation. However, closed SNS is used only for promoting friendship or entertainment on the basis of a human network. Regardless of the rapid increase in the number of users of closed SNS, it is difficult to find community members sharing a common taste, and accordingly to realize business related to sharing information and content that may be provided in an SNS.

Furthermore, there are cyber communities through which members having similar hobbies or interests may communicate over the internet. This enables a chatting room and bulletin board to be provided in an easily accessible online space on the internet so that community members may communicate with each other. In such a space, the propensities of people belonging to a community having similar interests are relatively clear and useful for marketing. However, since an individual trying to join a community as a member should search for a specific cyber community suitable for obtaining desired information or exchanging information, lots of time is wasted.

### Prior Art Literature

Korean Patent Application Laid-open Publication No. 10-2012-0138216

### SUMMARY OF THE INVENTION

Accordingly, the present invention has been made keeping in mind the above problems occurring in the prior art, and an object of the present invention is to provide a new method for establishing an online space for providing a social network service.

Another object of the present invention is to provide a social network service method for enabling the provision of content that matches the interests of group members in the foregoing online space and efficient consumption of the content.

Still another object of the present invention is to provide a social network service capable of readily responding to content request changes by a user.

In order to accomplish the above object, the present invention provides a method for providing a social network service (SNS) for providing a space for communication among subscribers belonging to a group online. The method includes: providing, by an SNS server, a group category in units of objects according to a request for group establishment by a service subscriber; generating, by the SNS server, a social network group related to a category selected by the service subscriber; storing, by the SNS server, the generated social network group in correspondence to the group category; and providing content related to the category of the social network group. According to an embodiment, the group category in units of objects may be set based on user's interest information, or may be set to include a theme pertaining to an expected event for a user or a theme pertaining to a task achievable by a user.

In order to accomplish the above object, the present invention provides a method for providing a social network service, including: setting, by an SNS server, a plurality of object unit categories including associated category information such that at least some of categories indicate another category, and forming a social network group belonging to the set category; providing, by the SNS server, a social network service to a subscriber of the social network group; querying, by the SNS server, whether to move the associated category to a terminal of a subscriber in a group belonging to a first category; and recommending, by the SNS server, a corresponding subscriber to subscribe to a social network group belonging to a second category indicated by the associated category information on the first category in response to a movement request from the terminal of the subscriber in the group belonging to the first category. According to an embodiment, the category may be set based on a theme pertaining to an achievable task, and when the subscriber achieves the task of the first category, the SNS server may transmit to the subscriber terminal a query about whether to move the second category. In addition, according to an embodiment, the first and second categories may be sequentially associated.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view schematically illustrating an exemplary communication environment for realizing a social network service according to an embodiment of the present invention;

FIG. 2 is a block diagram illustrating an exemplary component forming a service system according to an embodiment of the present invention;

FIG. 3 is a view conceptually illustrating an aspect of managing objective group information according to an embodiment of the present invention;

FIG. 4 is a block diagram illustrating in detail function blocks forming the SNS server according to an embodiment of the present invention;

FIG. 5 is a view schematically illustrating a procedure of establishing an objective group according to an embodiment of the present invention;

FIG. 6 is a view schematically illustrating an exemplary procedure of providing advertisement content to an objective group of the present invention;

FIG. 7 is a procedure diagram for schematically explaining a procedure of a subscriber's object group movement according to an embodiment of the present invention;

FIGS. 8 and 9 are views exemplarily illustrating user terminal interfaces for performing the group establishment procedure explained in relation to FIG. 5;

FIG. 10 illustrates a view illustrating an exemplary interface screen at the time of accessing an established group according to an embodiment of the present invention; and

FIG. 11 is a view exemplarily illustrating a user terminal interface for querying movement to a correlated category according to task completion of an objective group subscriber according to an embodiment of the present invention.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

The advantages and features of the present invention and the methods for achieving the same will be clarified with reference to exemplary embodiments, described later in detail together with the accompanying drawings. However, the present invention is not limited to the following exemplary embodiments, but can be realized in various forms. In other words, the present exemplary embodiments are provided just to complete the disclosure of the present invention and make a person having ordinary skill in the art understand the scope of the invention. The present invention is to be defined only by the scope of the accompanying claims. Throughout this specification, like numerals refer to like elements.

In the specification of the present invention, “an objective group” is used in a sense including a group formed of a plurality of members sharing at least an identical or similar object on the basis of an individual human network.

According to an embodiment of the present invention, an ‘object’, as a criterion for classifying groups, includes a theme set in various schemes on the basis of interest information common to group members, but is distinguished from the human relationships between group members. For example, hobbies of the members may be included as the interest information, but what school they are from, what area they are from, or their workplace is unsuitable as a theme for classifying the group. For example, the ‘object’ may be set as an event that is expected to happen to the group members as a theme. For example, ‘childbirth’ is an event that is expected to happen to a pregnant couple as time passes and may accordingly correspond to an ‘object’ in the present invention. In addition, ‘move’ is an event that is expected to happen to a resident at a predetermined time, either according to or against the resident's will. ‘study abroad’ and ‘overseas travel’ are also events that are expected to happen to a person having a corresponding goal. In addition, the “object” may be set as a theme pertaining to an achievable task. For example, ‘home ownership’ is an achievable task to group members, and may become a category for classifying the objective group of the present invention.

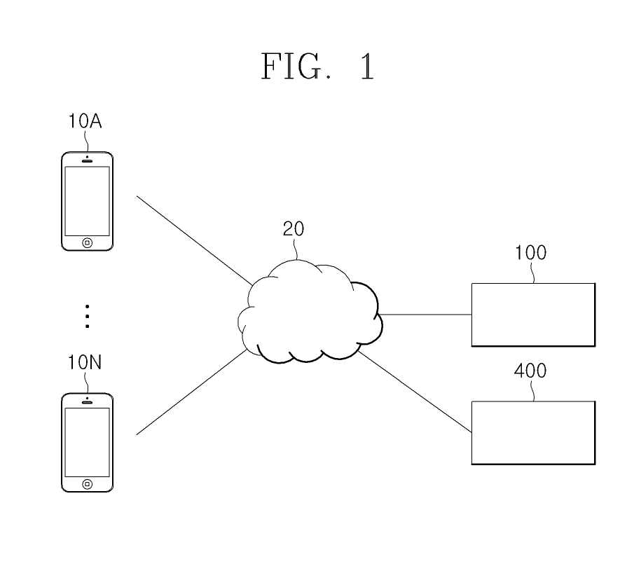

FIG. 1 is a view schematically illustrating an exemplary communication environment for realizing a social network service according to an embodiment of the present invention.

FIG. 1 illustrates a plurality of user terminals 10A to 10N connected to a network 20, an SNS server system 100, and an advertisement server system 400.

The network 20 in the present invention may include a local area network (LAN), a wide area network (WAN), or other communication networks. The user terminals 10A to 10N in the present invention may include a computer-readable memory, a processor, and a display to execute one or more applications. For example, the client nodes 10A, 10B, . . . and 10N may be mobile terminals, such as smartphones.

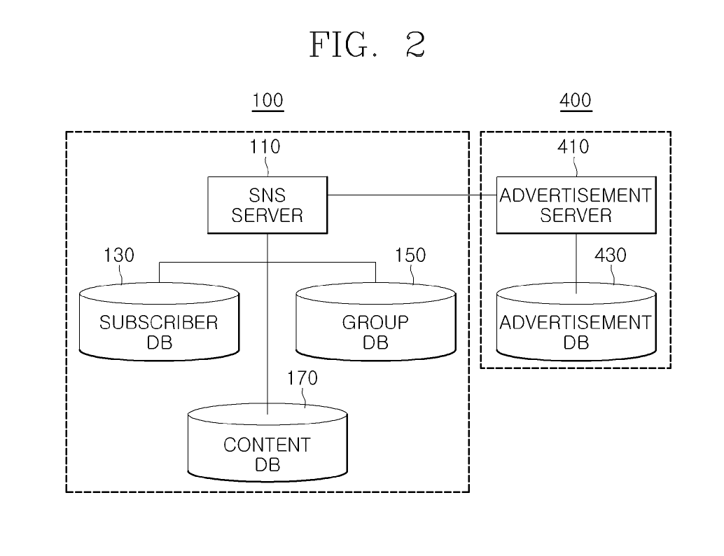

FIG. 2 is a block diagram exemplarily illustrating the components forming the SNS server system 100 and the advertisement server system 400 illustrated in FIG. 1.

Referring to FIG. 2, the SNS server system 100 includes an SNS server 110, a subscriber DB 130, and a group DB 150.

The SNS server 110 provides a social network service in response to a request from a user terminal through the network. In addition, the SNS server 110 establishes an objective group according to an objective group establishment request from the user terminal and manages the objective group in the present invention.

The subscriber DB 130 stores profile information on a service subscriber. The service subscriber profile information may include personal information such as the gender, age, name, address, and phone number of a subscriber. In addition, the subscriber profile information may include the subscriber's payment information. Additionally, the service subscriber profile information may include the subscriber's address book information.

In addition, the subscriber DB 130 may additionally include profile information, namely, group profile information and/or group subscriber profile information, related to a group to which the service subscriber has subscribed. The group subscriber profile information may include profile information requested when a user subscribes to a corresponding group in correspondence to the group to which the user belongs. For example, in the case of a group belonging to the category of ‘pregnancy/childbirth’, a due date may be managed as group subscriber profile information. In another example, for a group belonging to the category of ‘home ownership’, the type or size of home desired by a user may be managed as group subscriber profile information. The group subscriber profile information may group users having similar profile information as one group, or may be used as information for selecting the group to which the user is to belong.

Furthermore, users of similar profiles, who have an identical object, may belong to different groups from each other within a category. In this case, the present invention enables identical content to be provided to various groups to which similar users belong by analyzing the group subscriber profile. In addition, the subscriber DB 130 may store a history of actions performed by a subscriber as a group member. For example, when the subscriber reacts to content by means of a click or comment, such a reaction may be stored in the subscriber DB 130 as an interaction in response to the corresponding content.

Furthermore, the group DB 150 stores information on the established objective group. The objective group information may include a group category and a group list corresponding to the group category.

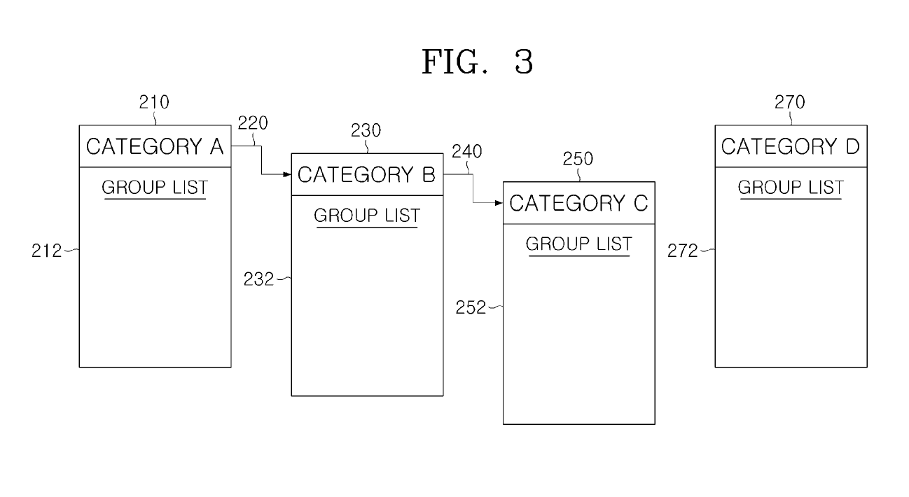

FIG. 3 is a view conceptually illustrating an aspect of managing objective group information according to an embodiment of the present invention.

Referring to FIGS. 2 and 3, a plurality of categories 210, 230, 250, and 270 respectively correspond to group lists 212, 232, 252, and 272. For example, the category of “pregnancy/childbirth” corresponds to a list of established groups belonging thereto.

In addition, the objective group information may include information on an associated category. In FIG. 3, associated category indicators 220 and 240 are represented as connection lines connecting categories. The associated category indicators 220 and 240 show that these categories are associated with each other. In addition, the direction of the associated category indicators 220 and 240 may represent a relevant sequential temporal relationship between two categories. When the two categories have a bidirectional temporal relationship, the associated category indicator may be represented as a bidirectional arrow.

For example, since the category of ‘pregnancy/childbirth’ has a sequential temporal correlation with the category of ‘child care’ associated therewith, the associated category indicator may be represented as an arrow heading from the pregnancy/childbirth category to the infant care category. Similarly, the category of ‘rental house preparation’ has a high association with the category of ‘home ownership,’ and the category of ‘retirement savings arrangement’ may also be a theme having high association with these categories, based on the common interest information on financial planning. Accordingly, a sequential temporal correlation is given in the order of ‘rental house preparation’, ‘home ownership’ and ‘retirement savings arrangement’ categories, and a bidirectional correlation may be given therebetween. As will be described below, the association category information may be used as basic information for group recommendation when group members move between groups.

In the present invention, the associated category information may be added in a data type representing an identifier of an object category. In addition, the associated category information may be stored in the group DB 150, or the SNS may be managed as a separate table.

Referring to FIG. 2 again, the SNS server system 100 according to an embodiment of the present invention may include a content DB 170. The content DB 170 stores content provided or to be provided to the objective group. The content stored in the content DB 170 may be received from an external content server.

In addition, the content provided to the objective group in the present invention may include advertising content received from an external advertisement infrastructure. In other words, the content to be provided in the present invention may include advertising, or may be content that includes a link to the advertisement. To this end, the SNS server 110 may be connected to an external advertisement server system 400. The advertisement server system 400 may include an advertisement server 410 for providing advertisements and an advertisement DB 410 for storing advertisement-related information.

In the above-described case, the SNS server system 100 includes various databases, but the embodiment is not limited hereto. For example, the databases may be integrated into one database or separated into a greater number of databases by functional unit.

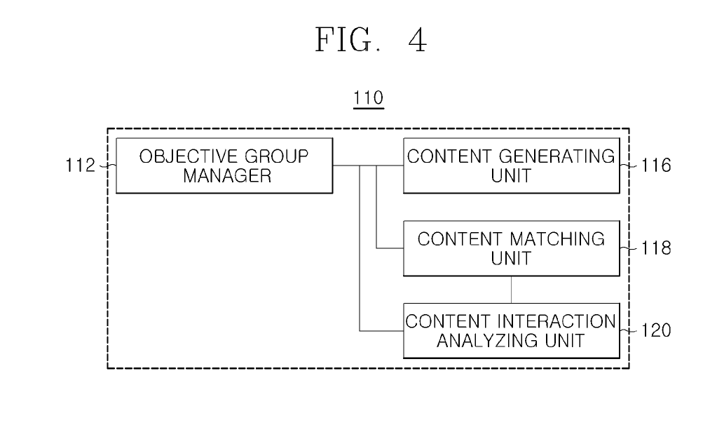

The SNS server 110 in the present invention establishes a group according to a group establishment request by a user, runs a corresponding group, and manages content to be posted to the corresponding group. FIG. 4 is a block diagram illustrating in detail function blocks forming the SNS server 110 according to an embodiment of the present invention.

Referring to FIG. 4, the SNS server 110 may include an objective group manager 112, a content generating unit 116, a content matching unit 118, and a content interaction analyzing unit 120.

The objective group manager 112 establishes an SNS group and manages the established group. To this end, the objective group manager 112 controls each operation of the content generating unit 116, the content matching unit 118, and the content interaction analyzing unit 120.

The objective group manager 112 manages the objective group according to a preset category. As described above, the category may be classified based on a user's interest information, and ‘pregnancy/childbirth’, ‘move’, ‘study abroad’, ‘travel’, ‘interior’, ‘operation’ ‘financial planning’, and the like are examples of such categories.

The objective group manager 112 may communicate with a client application of the user terminal 10A to 10N for providing an SNS. That is, the objective group manager 112 may include an additional component for making and reading a notice, and posting content in an online space allocated to the group subscriber.

The objective group manager 112 may refer to the group DB 150 for managing the objective group.

The content generating unit 116 generates content to be provided to the objective group. As described above, the content may be advertising content, and the content generating unit 116 may make the format of content received from outside suitable for posting to the group space.

The content matching unit 118 matches content suitable for posting to a group among the generated content. Content matching is performed in a method whereby a keyword is extracted and a match between the extracted category and the content is determined.

The content interaction analyzing unit 120 analyzes the interaction between the content and group members. Such interaction includes, for example, whether to read, whether to click through, whether to leave a comment, or the like for the posted content. The result of analysis from the content interaction analyzing unit 120 may be used for verifying the suitability of matching between the content and the group at the time of content matching.

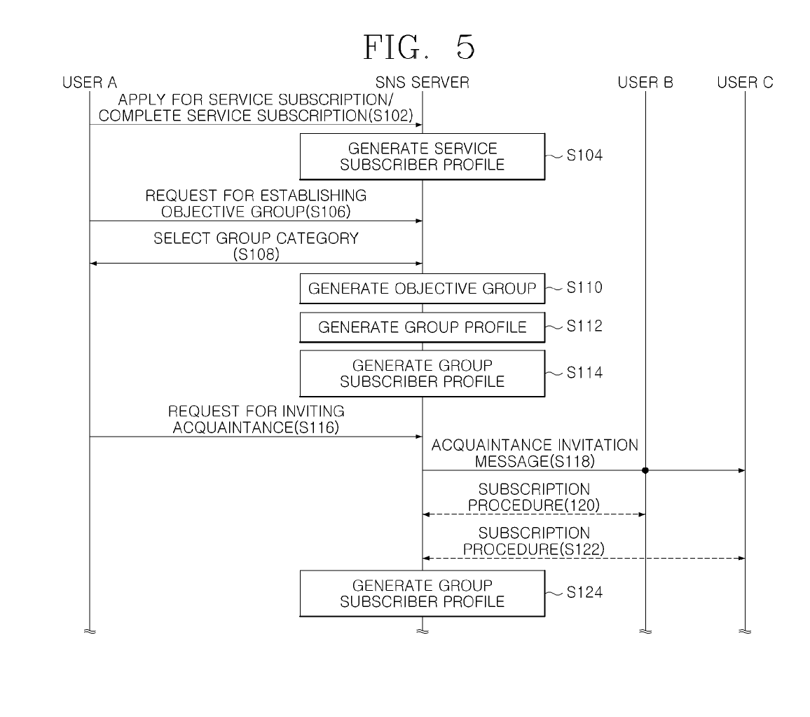

FIG. 5 is a view schematically illustrating an objective group establishing procedure according to an embodiment of the present invention.

When an arbitrary user A accesses the SNS server 110 and inputs personal information for subscribing, a service subscribing procedure is completed (operation S102). The SNS server 110 generates a service subscriber profile on the basis of the subscriber information (operation S104).

When the user A requests establishment of an objective group (operation S106), the SNS server 110 transmits group categories for the objective group and receives information on the selected category from the user (operation S108). When the name of the group to be established is given by the user A, the SNS server generates a corresponding group (operation S110).

In the present invention, group profile information is generated for the established objective group (operation S112). To this end, the SNS server 110 requests an input for corresponding information from the user A and generates the group profile information. The group profile information represents a group or includes information representing group attributes, for example, ‘due date for childbirth’, ‘local area of childbirth’, ‘fetus's gender’, ‘household income’, or ‘possession or not of real estate’, or ‘information on consumption patterns’, for example, information on the level or grade (e.g., expensive, or cheap tastes) of childbirth preparation material desired by a couple. Some or all of the items of the generated group profile information may overlap with items of group subscriber profile information to be described later. However, the group profile information is to represent the attributes of the group, and is distinguished from the group subscriber profile information, which represents the subscriber's attributes. For example, the household income is distinguished from the income of an individual subscriber, whereas a housewife is treated as a dependent, represented by a corresponding group, and the group profile information may provide a determination basis therefor.

In addition, the SNS server 110 may receive additional group subscriber information from the user A and generate the group subscriber profile information (operation S114). The group profile information includes subscriber profile information on a corresponding group. As described above, when the group is a group of ‘pregnancy/infant care’, the profile information may be information such as the expected childbirth date.

When receiving a friend invitation request including a friend contact number from the user A (operation S116), the SNS server transmits a friend invitation message to designated users B and C (operation S118).

When the users B and C have received the invitation message request for subscribing in response to the message, a procedure for subscribing is performed on corresponding users in accordance with the foregoing subscribing procedure (operations S120 and S122). When the subscribing of the corresponding users is completed, a group subscriber profile may be generated for the corresponding subscriber (operation S124).

Although a description has been made above on the basis that a group is subscribed and a group subscriber profile is generated in sequence, the subscribing and generation of the group subscriber profile may be performed in reverse order.

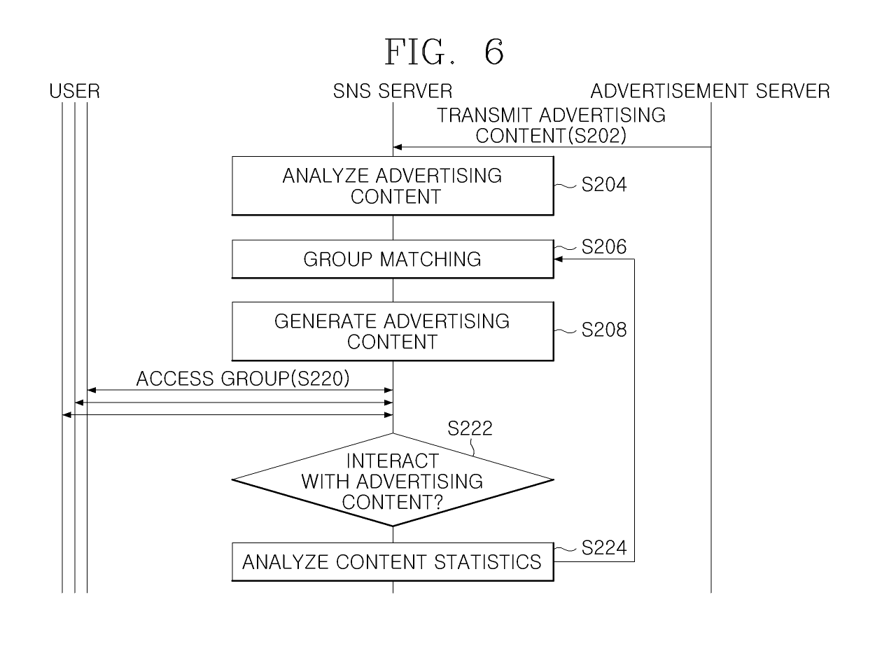

FIG. 6 is a view schematically illustrating an exemplary procedure of providing advertising content to an objective group of the present invention.

Referring to FIG. 6, when advertising content is transmitted from the advertisement server 410 (operation S202), the SNS server 110 analyzes the advertising content (operation S204) and matches it with the group to which the advertising content is to be posted (operation S206). The analysis of advertising content and the group matching may be performed based on the advertising content. At this point, various analysis methods may be used, including text extraction from the advertisement and keyword matching. Unlike this, the advertising content may include information for designating an objective group category. In other words, an advertiser or a manager of the advertisement server may designate a specific category among objective group categories of the present invention to include information thereon in the advertising content, and transmit the advertising content.

When the matching of the advertising content with the objective group is completed, the advertising content may be remade in a format suitable for posting, and the content may be posted in an online space accessible by the user who is a group member (operation S208).

Thereafter, it is monitored whether there is an interaction, such as the case where a user who is a group member reads the posted content, accesses a webpage linked to the content, and makes a comment (operation S222). The monitored interaction may be statistically analyzed based on content (operation S224). The interaction analysis result for the content may be fed back to be used for matching the content with the group. The interaction may be analyzed for all the groups where corresponding content is posted, and may be used for identifying a group having high similarity among groups in the same category. Unlike this, similarity with a group may be analyzed by identifying the group profile information. Through this, content having a high interaction with a specific group may be matched with other groups having group profile information similar to the corresponding group.

As another example, group profile information on groups to which subscribers in the specific group have belonged before may be used for content matching. For example, group profile information on a specific childbirth group to which a couple belongs may be referred to for content matching for a corresponding group when the couple establishes another group, for example, an infant care or travel group. In other words, a group having a pattern of expensive consumption preferences may be matched with content suitable for a consumption pattern corresponding thereto.

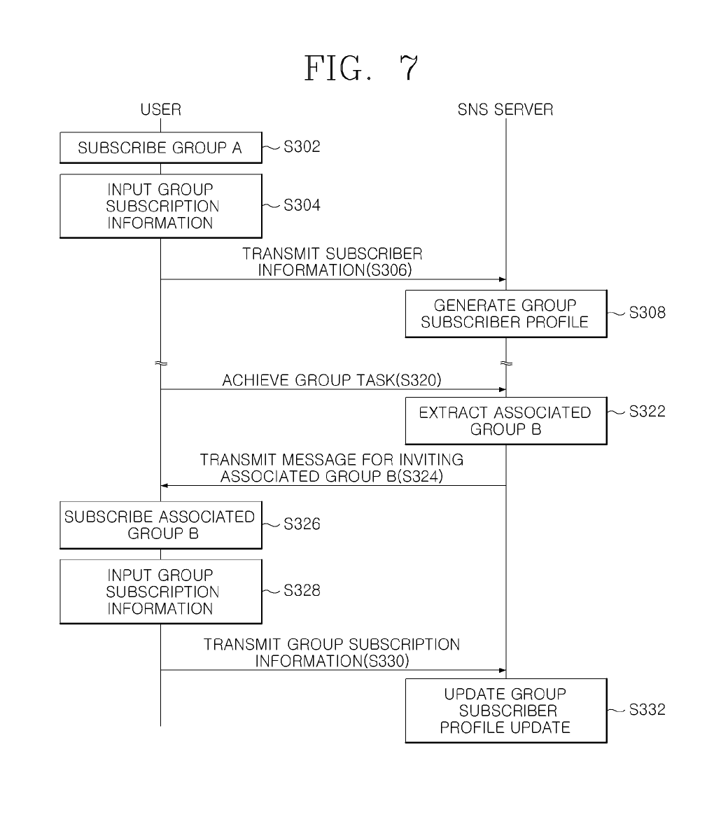

FIG. 7 is a procedure diagram for schematically explaining an objective group movement procedure of a subscriber according to an embodiment of the present invention.

Referring to FIG. 7, when a user subscribes to an arbitrary group A of a predetermined category (operation S302) and inputs group subscription information (operation S304), the group subscription information is transmitted to the SNS server 110 (operation S306). The SNS server 110 generates a group subscriber profile on the basis of the received group subscription information (operation S308), and completes a group subscribing process for a corresponding user.

When a user subscribing to the corresponding group achieves a task or object of the corresponding group, the corresponding subscriber does not have to act in the corresponding group. At this point, the SNS server 110 searches for and extracts another group related to the corresponding group (operation S322). For example, when the user is a subscriber of a specific group belonging to the category of ‘pregnancy/childbirth’ and does not need to act in the corresponding group any longer due to childbirth, the SNS server 110 extracts a group in a category of ‘infant care’, which is an associated category with the category of ‘pregnancy/childbirth’, and sends an invitation message for subscribing to the extracted group to the user (operation S324). In this case, the SNS server 110 may send to a corresponding user a message querying whether to achieve a task by using group subscriber profile information on the corresponding user and when the user responds thereto, may proceed with a process for extracting the associated group.

Unlike this, a request for moving to a group belonging to the associated category may be initiated by the user. For example, a user in a group belonging to a category of ‘rental house preparation’ may request for movement to an associated group when an object is achieved, and the SNS server 110 may send to the corresponding user an invitation message for subscribing a group in a category of ‘home ownership’.

In the present invention, various methods may be applied to select a group to be recommended to the corresponding user among groups belonging to the associated category. For example, personal information may be used which includes information on a gender, age, residence, or the like in user's service subscriber profile information. In addition, group subscriber profile information on a group to which the user have belonged before may also be used. For example, the user may be led to a group having similar group subscriber profile information on the basis of ‘house type’ or ‘size information’ input by the user in the ‘rental house preparation’ group.

In addition, a specific group may be recommended on the basis of a history of interactions performed by the user in an existing group. For example, group recommendation may be made to allow a user showing high interaction for specific content to belong to an identical group.

Referring to FIG. 7 again, when the user subscribes an associated group in response to the invitation message for subscribing the associated group (operation S326) and inputs group subscription information, and the group subscription information is transmitted (operations S328 and S330), the SNS server 110 applies the received group subscription information to the group subscriber profile information on the user to update the group subscriber profile information (operation S332), and completes a group move procedure for the user.

Hereinafter, a description is provided of the method for establishing and managing an objective group in the present invention in terms of the interface of a user terminal. A client application for realizing a social network service of the present invention is installed in the user terminal. The application provides a proper user interface for the social network service, such as group establishment, bulletin board reading, and the like.

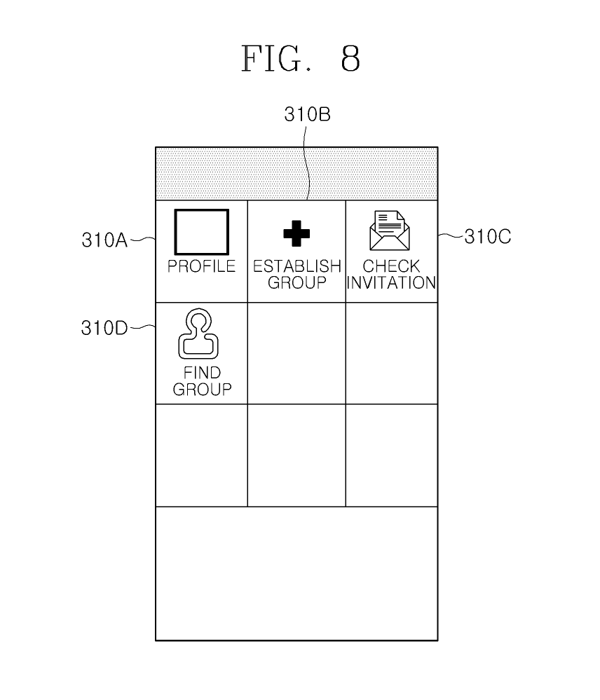

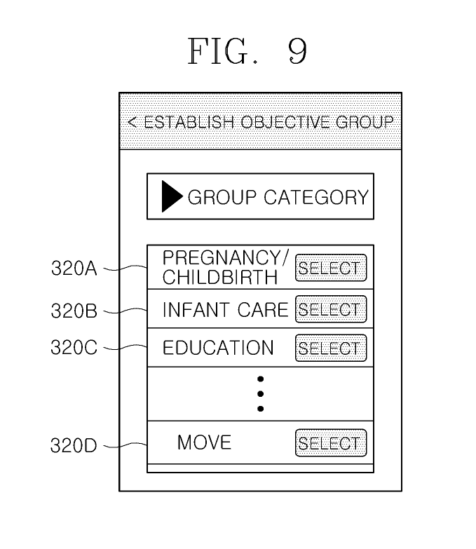

FIGS. 8 and 9 are schematic diagrams illustrating user terminal interfaces for performing the group establishment procedure explained in relation to FIG. 5. Descriptions of the embodiments exemplify, but are not limited to, a closed social network group service.

As exemplarily illustrated in FIG. 8, a user (i.e., service subscriber) receives menu items including ‘profile’ 310A, ‘establish group’ 310B, ‘check invitation’ 310C, and ‘find group’ 310D in respectively divided areas on the display of a user terminal, for example, the user terminal 10A shown in FIG. 1. The user may initiate a corresponding service by touching a corresponding area of a desired one among menu items provided on the display.

When the user touches ‘establish group’ 310B, a group establishment procedure is initiated and an objective group establishment screen may be displayed on the user terminal 10A, as illustrated in FIG. 9. As illustrated, group categories such as ‘pregnancy/childbirth’ 320A, ‘infant care’ 320B, ‘education’ 320C, and ‘move’ 320D are presented to the user. Although not separately illustrated, a search unit for facilitating a search for a category may be provided to the user terminal.

The user may select a specific category among the displayed categories and establish a new group in the selected category by inputting the name of the group to be established.

Although not separately illustrated, as described above, group establishment requires an input of group profile information and/or group subscriber profile information. For the category of ‘pregnancy/childbirth’, pieces of information related to the object of the corresponding group or required for the provision of related content may be input, which include information such as, for example, ‘due date of childbirth’, ‘childbirth area’, ‘gender of fetus’, ‘household income’, or information on a consumption pattern (e.g., expensive tastes, cheap tastes, or the like) as group profile information representing group attributes and subscriber profile information for a corresponding group.

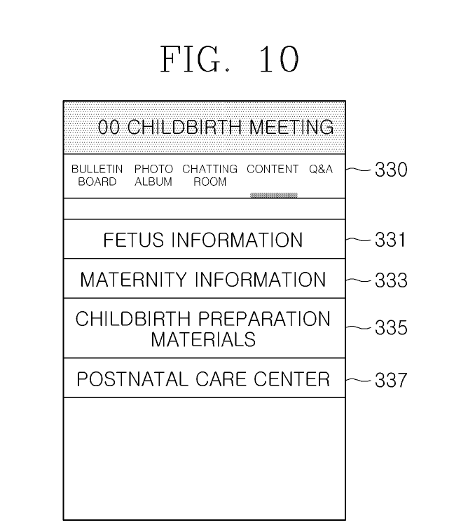

FIG. 10 is a view illustrating an interface screen for accessing an arbitrary group established in the ‘pregnancy/childbirth’ category.

A bulletin board menu 330 is provided at a proper position, such as an upper corner of the screen. When a user selects a content menu of the bulletin board menu 330, content items 331, 333, 335, and 337, related to a corresponding group, are displayed. The user may access corresponding content by touching a corresponding item.

In the present invention, various pieces of interest information on the corresponding group may be provided as the content. For example, the content may be any one of information content, commercial transaction content, and regional content. For example, the information content may include fetal growth information, maternity health information, insurance information, and the like, and the commercial transaction content may include content about childbirth preparation materials. In addition, the regional content may include information on a postnatal care center, photo studio, and hospital.

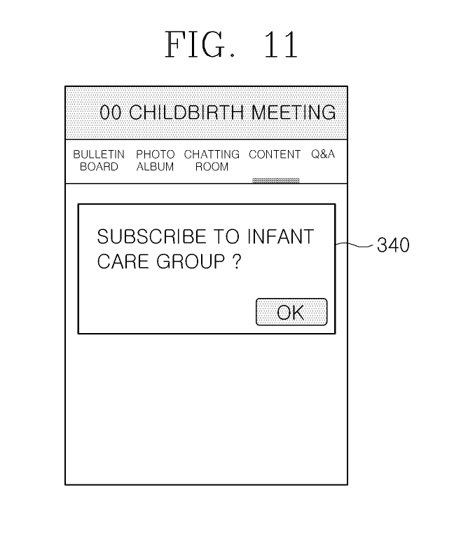

FIG. 11 is a view exemplarily illustrating a user terminal interface for facilitating movement to an associated category according to task completion of an objective group subscriber according to an embodiment of the present invention.

As illustrated, a message for recommending subscribing to a group on infant care, which has a close sequential association to a group on ‘pregnancy/childbirth’, is sent to the user terminal 10A from the SNS server 110 on the basis of whether to complete a task by a user or a user's request, and is displayed on the user terminal. When the user approves this, the SNS server 110 leads the user to a group belonging to a corresponding category and to proceed with a procedure for subscribing to or establishing the group.

As described above, according to an embodiment of the present invention, it is possible to provide meaningful content to groups, and to compensate for the weakness of the human network-oriented closed SNS by forming a social network group on the basis of information on user interests.

In addition, according to an embodiment of the present invention, meaningful analysis of the interaction between content and users is made possible by grouping the users on the basis of information on common interests, and the availability of the advertising business in SNS can be increased by reflecting the analysis results in content provision.

In addition, according to an embodiment of the present invention, user movement between groups can be facilitated, and content tailored to the user request can be provided in a timely manner by applying a correlation to classified categories.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for providing a social network service (SNS) for providing a communication space among subscribers belonging to a group online, the method comprising:
providing, by an SNS server, a plurality of group categories in units of objects according to a request for group establishment by a service subscriber;
generating, by the SNS server, a social network group related to a group category selected by the service subscriber;
storing, by the SNS server, the generated social network group in correspondence to the selected group category; and
providing content related to the selected group category of the social network group.

2. The method of claim 1, wherein the group category in units of objects is set based on the service subscriber's interest information.

3. The method according to claim 1, wherein the group category in units of objects comprises a theme pertaining to an expected event for the service subscriber.

4. The method according to claim 1, wherein the group category in units of objects comprises a theme pertaining to a task achievable by the service subscriber.

5. The method according to claim 1, wherein the group category in units of objects comprises at least one selected from among groups pertaining to pregnancy, childbirth, infant care, moving, interior design, financial planning, overseas travel, plastic surgery, and studying abroad.

6. The method according to claim 1, further comprising inviting, by the SNS server, a second subscriber on the basis of second subscriber information received from the service subscriber requesting the group establishment.

7. The method according to claim 1, wherein the content is advertising content matching the selected group category of the social network group.

8. The method according to claim 7, wherein the advertising content matching is determined based on an interaction between advertising content provided to the social network group and a user in the social network group.

9. The method according to claim 8, wherein the generating the social network group further comprises generating group profile information, and
the advertisement content matching is determined based on the group profile information.

10. A method for providing a social network service, comprising:
setting, by an SNS server, a plurality of object unit categories comprising associated category information in which at least some of object unit categories indicate another category, and forming a social network group belonging to set categories;
providing, by the SNS server, a social network service to a subscriber of the social network group;
querying, by the SNS server, whether to move an associated category to a terminal of a subscriber in a group belonging to a first category; and
recommending, by the SNS server, a corresponding subscriber to subscribe a social network group belonging to a second category indicated by the associated category information on the first category in response to a movement request from the terminal of the subscriber in the group belonging to the first category.

11. The method according to claim 10, wherein the set categories are set based on a theme pertaining to a task, and
when the subscriber in a group belonging to a first category achieves the task of the first category, the SNS server transmits to the subscriber terminal a query about whether to move the second category.

12. The method according to claim 10, wherein the first and second categories are sequentially associated.

13. The method according to claim 10, wherein the providing the social network service comprises:
providing content matching the set categories to a user in the social network group; and
monitoring interaction between the user and the content,
wherein the recommending is to recommend a group to which a user in the second category belongs on the basis of the interaction with the content.
